(19) United States
(12) Patent Application Publication
(10) Pub. No.: US 2005/0171793 A1
(43) Pub. Date: Aug. 4, 2005

(54) Motivational/incentive system and method

(76) Inventors: Bennie Ray, Bentonville, AR (US); Gary Metcalfe, Bentonville, AR (US)

Correspondence Address: BRENT A. CAPEHART;LaRiviere, Grubman & Payne, LLP, 19 Upper Ragsdale Drive, Suite 200, P.O Box 3140, Monterey, CA, 93940, US

(21) Appl. No.: 10/769,452

(22) Filed: Jan. 30, 2004

(51) Int. Cl. G06F 17/60

(52) U.S. Cl. 705/1

(57) ABSTRACT

The present invention provided for an apparatus which provides an incentive to motivate a person or group of persons having a board having a front side and a backside. A plurality of reward zones is located on the front side of the board. A plurality of reward indicia is also located on the front side of the board. Each of the plurality of reward indicia is associated with one of each of the plurality of reward zones. The reward zones can consist of various types, including a plurality of removable tabs and a plurality of sections of removable coating.

### REFERENCE TO PENDING APPLICATIONS

This application is not based upon any pending domestic or international patent applications.

### REFERENCE TO MICROFICHE APPENDIX

This application is not referenced in any microfiche appendix.

### BACKGROUND OF THE INVENTION

1. Field of the Invention

The present invention is generally directed toward a motivational/incentive system and method. More specifically, the present invention is directed toward an interactive motivational/incentive system utilizing a reward system.

2. Background

The ability to motivate an individual or a workforce into doing a particular action is a constant challenge. It is common to provide an incentive, such as a financial reward or gift, in order to motivate a person into taking a specific action.

An example of using an incentive to motive includes providing an employee with a year-end bonus, provided that the employee remains with the Company through the course of the year. The employee is motivated by the belief that she will receive something of value, i.e. additional money, valuable gift or otherwise, at the end of the year bonus to maintain her employment with the Company. However, this common motivational technique has disadvantages. This technique include the uncertainties of actually receiving a year-end bonus and/or the amount of the bonus. If no year-end bonus is received or if the bonus is not what the employee expected, the employee will not only be demoralized but could actually be motivated to leave the employment of the company.

Additionally, in the retail market, it is a constant challenge to motivate the purchasing public into making a purchase. Incentives have been used in the prior art to provide such motivation. One such example involves the sale of automobiles. The automobile dealership desires to sell a vehicle to the public. In order to do this, the dealership utilizes various incentives, such as price reductions and test drives, to encourage the consumer to purchase a vehicle. However, over time these prior art incentive systems do not keep the consumers' level of interest sufficient to make a purchase.

Thus, there is a need to provide a system which can provide a more reliable motivational incentive.

### BRIEF SUMMARY OF THE INVENTION

The present invention satisfies the needs stated above. The present invention is generally directed toward a motivational/incentive system and method. More specifically, the present invention is directed toward a motivational/incentive system utilizing an interactive incentive board having a plurality of reward zones to provide various rewards.

In one aspect, the present invention provides a system which creates an incentive for a person to perform an action by allowing that person a chance at a reward in exchange for doing that action. This system includes having a game board with a plurality of reward zones on one side of the game board. Each of these reward zones have a reward associated therewith.

The reward zones can take a variety of forms. One variety includes having each of the reward zones being a section of the game board covered by a removable coating. This coating is capable of being removed by a scratching, rubbing or other similar process. The reward associated with each of the reward zones would be printed on the board under the removable coating. Once the coating was removed, the reward would be exposed for view by the person.

Another variety of reward zones would be a plurality of removable tabs, each of which having a reward printed thereon. The reward would be revealed once the tab was removed from the game board. One skilled in the art would recognize that the reward could be printed on either the tab or the game board under the tab.

The game board can include various other images and indicia. Such indicia can include a wide variety of items, such as motivational images and sayings, company logos and advertisements.

In one aspect of the operation of the present invention, a person is allowed to choose a reward zone in exchange for performing an action or a series of actions. The manner by which this is accomplished is determined by the type of reward zone being used. In the instance where the reward zones are a plurality of removable tabs, the user removes one of the tabs whereby determining the underlying reward. In the instance where the reward zones are a plurality of coated sections, the person rubs or scratches the coating off, exposing the underlying reward.

Further features of the present invention will be apparent to those skilled in the art upon reference to the accompanying drawings and upon reading the following description of the preferred embodiments.

### BRIEF DESCRIPTION OF THE DRAWINGS

FIG. 1 is a perspective view of an embodiment 10 of the present invention.

FIG. 2 is a perspective view of an additional embodiment 100 of the present invention.

FIG. 3 is a perspective view of an additional embodiment 150 of the present invention.

FIG. 4 is a perspective side view of embodiment 150 of the present invention.

FIG. 5 is a schematic view of an embodiment of the method of the present invention.

### DETAILED DESCRIPTION OF THE PREFERRED EMBODIMENTS

Before explaining the present invention in detail, it is to be understood that the invention is not limited to the preferred embodiments contained herein. The invention is capable of other embodiments and of being practiced or carried out in a variety of ways. It is to be understood that the phraseology and terminology employed herein are for the purpose of description and not of limitation.

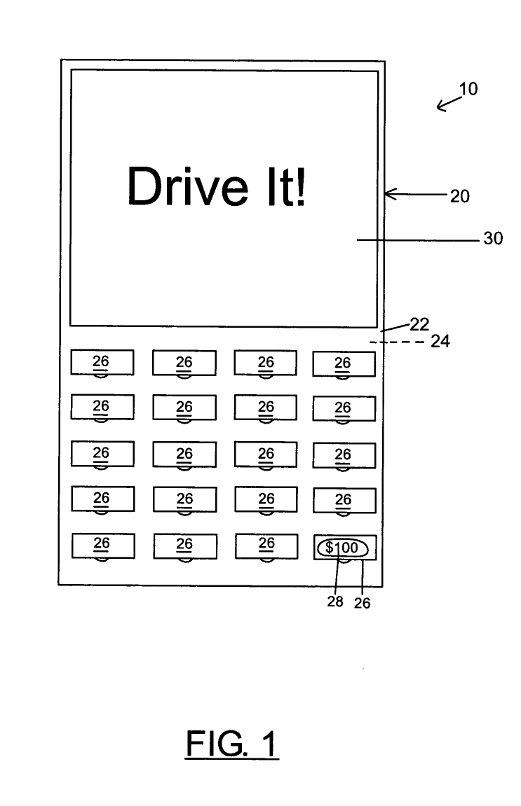

Illustrated in FIG. 1 of the embodiment 10 of the present invention comprises a game board 20 having a front side 22 and a backside 24. Positioned on front side 22 is a plurality of removable tabs 26. Under each of the plurality of removable tabs 26 is a reward indicia 28. Removable tabs 26 represent an embodiment of the reward zones of the present invention. Reward indicia 28 is a representation of the particular reward associated with that particular reward zone. Such indicia can include a representation of a particular amount of money, a particular gift or other item of value.

An additional element of embodiment 10 includes indicia 30 on the front 22 of game board 20. Indicia 30 can be a company logo, motivational illustration or saying, photograph or other illustration or graphic.

Those skilled in the art will recognize other types of reward zones are within the scope of the present invention and the use of removable sections is merely illustrative and is not meant to be limiting. Further, those skilled in the art will recognize that the reward indicia can be either printed on each of the plurality of removable tabs 26 or printed on the game board 20.

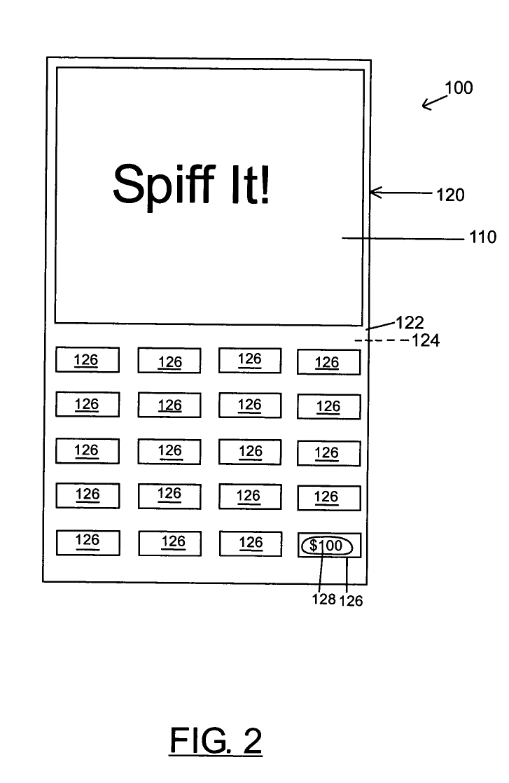

As shown in FIG. 2, an additional embodiment 100 of the present invention is illustrated. Embodiment 100 comprises a game board 120 having a front side 122 and a backside 124. Positioned on front side 122 is a plurality of sections of removable coatings 126. Each of the plurality of sections of removable coatings 126 can be removed by a scratching or rubbing action caused by a fingernail or coin or other simpler removal movement. Under each of the plurality of removable coatings 26 is a reward indicia 128. While the reward zones of this embodiment 100 are shown to be removable coatings 126, those skilled in the art will recognize that other embodiments which cover and later expose the reward indicia is with in the scope of the present invention, the use of the removable coatings are merely illustrative and are not limiting.

An additional element of embodiment 100 includes indicia 110 on the front 122 of game board 120. Indicia 110 can be a company logo, motivational illustration or saying, photograph or other illustration or graphic.

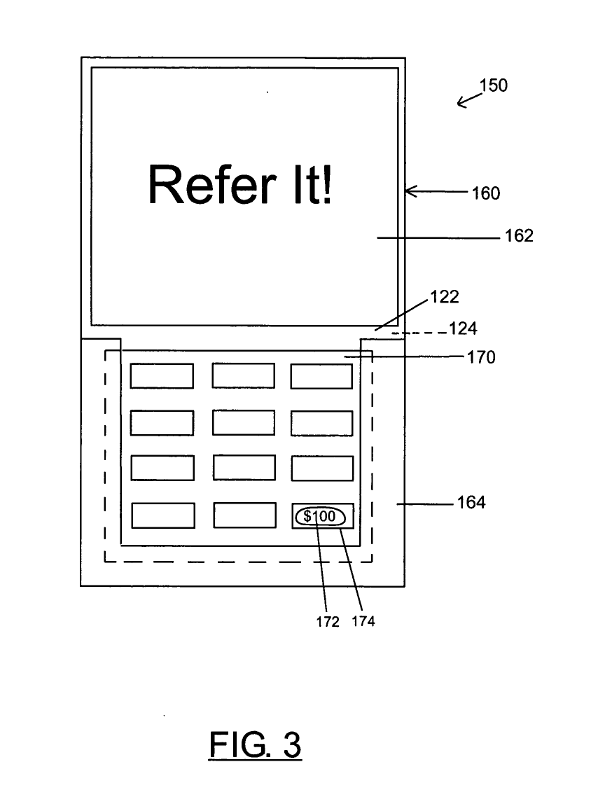

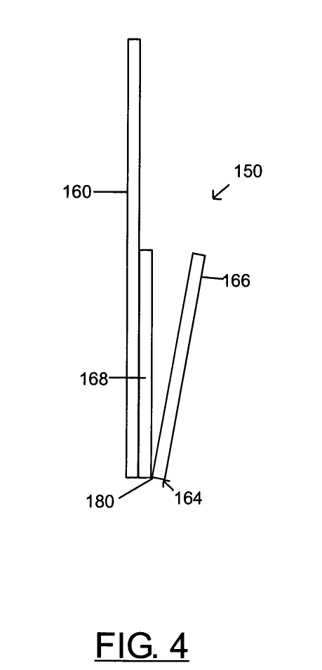

As shown in FIGS. 3 and 4, an additional embodiment 150 of the present invention is illustrated. Embodiment 150 comprises a game board 170 as described above and a support board 160 having a frame 164 to support said game board 170. In embodiment 150, frame 164 has a front portion 166 and a back portion 168. The back portion 168 is permanently secured to the support board 160. The front portion 166 is pivotally connected to the back portion 168.

Game board 170 is secured within frame 164 by sliding into a groove (not shown) within back portion 168. Front portion 166 is raised and lowered to allow access to the game board 170. While this embodiment is shown with the front portion pivotally connected, it is within the scope of the invention that a non-pivoting frame be employed.

In this embodiment, support board 160 is larger, or has a greater dimension, than the game board 170. This allows for informational indicia 162 to be placed on the support board 160. Informational indicia 162 can be a company logo, motivational illustration or saying, photograph or other illustration or graphic.

By utilizing a support board 160 and a game board 170 in combination allows for the removal and replacement of a game board 170 once a significant number of reward zones 172 have been exposed without the need of replacing the entire display.

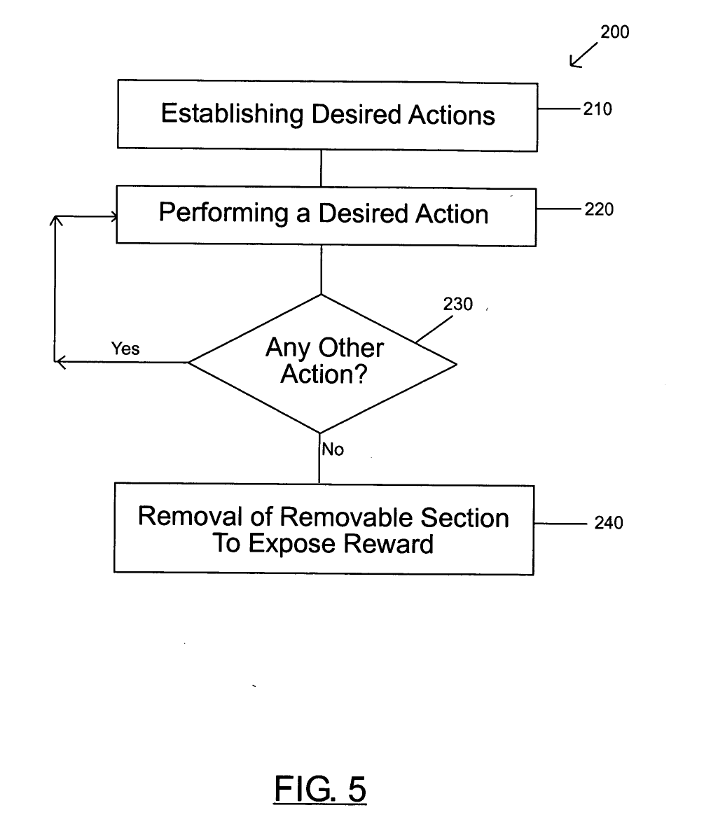

As shown in FIG. 5, an embodiment 200 of the operation of the present invention is disclosed. This embodiment 200 involves providing an incentive for a person to perform one or more particular actions. These actions are pre-established, as shown in step 210. The person then performs an action, as shown in step 220. In the event more than one action is required, the person performs the additional actions, as shown in step 230. The person is then able to uncover a particular reward from the inactive incentive board as defined above, as shown in step 240.

An example of this embodiment involves an automobile dealership wanting to motive a person to test drive an automobile. After the person test drives an automobile, the person is able to expose a reward, in the form of cash or otherwise, from the interactive incentive board described above. In the event the dealership wants to track those people who test drive the vehicles, the person would also be required provide various biographical information prior to selecting a reward.

An additional example of embodiment 200 involves providing an incentive for employees to perform at a high level of competence during the course of a year. At the end of a particular time period, such as a month, an employee who has satisfied pre-established performance criteria is able to remove one of the removable sections, revealing a monetary amount underneath. Depending upon the extent of the incentive, the employee could receive the monetary amount at that time or be required continue to working until the end of the year in which to receive that amount. This system allows for employees to have definite rewards based on performance, eliminating the uncertainty associated with prior art motivational techniques.

An additional example of this embodiment involves the receiving of business referrals. A large portion of business is conducted based on referrals from various individuals, including current and past customers, clients, associates, etc. It is common for a business to ask its customer base to provide the contact information of other who may be in need of the business's good or services. This is sometimes referred to as obtaining a lead. This example allows a person to select a reward after they have provided the business with one or more leads.

While the invention has been described with a certain degree of particularity, it is understood that the invention is not limited to the embodiments set forth herein for purposes of exemplification, but is to be limited only by the scope of the attached claims or including the full range of equivalency to which each element thereof is entitled.

1. An apparatus to provide an incentive comprising:
a game board having a front side and a backside;
a plurality of reward zones located on said front side of said game board; and
a plurality of reward indicia located on said front side of said game board, wherein one of each of said plurality of reward indicia being associated with one of each of said plurality of reward zones.

2. The apparatus of claim 1 wherein said plurality of reward zones comprises a plurality of removable tabs.

3. The apparatus of claim 2 wherein one each of said plurality of reward indicia is located on one each of said plurality of removable tabs.

4. The apparatus of claim 2 wherein each said plurality of reward indicia is located on said front side of said game board under one each of said plurality of removable tabs.

5. The apparatus of claim 1 wherein said plurality of reward zones comprises a plurality of sections of removable coating and wherein one of each of said plurality of reward indicia is located on said front side of said game board under one of said plurality of sections of removable coatings.

6. The apparatus of claim 1 further comprising one or more informational indicia on said front side.

7. The apparatus of claim 1 further comprising a support board having a frame to support said game board.

8. The apparatus of claim 7 wherein said frame has a front portion and a back portion, said back portion being permanently secured to said support board, said front portion being pivotally connected to said back portion.

9. The apparatus of claim 7 wherein said support board has a larger dimension than said game board.

10. The apparatus of claim 9 further comprising a support board having one or more informational indicia thereon.

11. A method to provide an incentive utilizing a board having a front side and a backside, a plurality of reward zones located on said front side of said board, and a plurality of reward indicia located on said front side of said board, wherein one of each of said plurality of reward indicia being associated with one of each of said plurality of reward zones, said method comprising the steps of:
providing one or more actions for a person to perform;
allowing said person to expose said reward indicia after said one or more actions have been performed, said reward indicia identifying a particular reward to be provided to said person; and
providing said reward to said person.

12. The method of claim 11 wherein said plurality of reward zones comprises a plurality of sections of removable coating and wherein one of each of said plurality of reward indicia is located on said front side of said board under one of said plurality of sections of removable coatings.
